(19) United States
(12) Patent Application Publication
(10) Pub. No.: US 2008/0187679 A1
(43) Pub. Date: Aug. 7, 2008

(54) Cationic polymerizable composition, and recorded material, image forming process, ink set, and inkjet recording method using the same

(75) Inventors: Takehiko Sato, Ashigarakami-gun (JP); Hisato Nagase, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku (JP)

(21) Appl. No.: 11/882,011

(22) Filed: Jul. 30, 2007

(30) Foreign Application Priority Data
Jul. 28, 2006 (JP) 2006-207009

(51) Int. Cl. C08F 2/48; C08G 65/18; B05D 5/04

(52) U.S. Cl. 427/508; 528/417; 524/612; 427/265

(57) ABSTRACT

The invention provides a cationic polymerizable composition comprising at least one oxetane compound containing an unsubstituted methyl group and at least one oxirane compound containing an unsubstituted methyl group.

### CROSS-REFERENCE TO RELATED APPLICATION

This application claims priority under 35USC 119 from Japanese Patent Application No. 2006-207009, the disclosure of which is incorporated by reference herein.

### BACKGROUND OF THE INVENTION

1. Field of the Invention

The invention relates to a cationic polymerizable composition having a low viscosity and superior curing properties and a recorded material, an image forming process, an ink set and an inkjet recording method using the same.

2. Description of the Related Art

Recently, inkjet printing methods that do not require printing plates have become common in cases in which a limited number of printing documents are printed, such as large posters and posters for local advertisements.

Inks such as aqueous ink, solvent-based ink and UV-curable ink have generally been used for ink-jet inks.

When printed on plain paper, aqueous inkjet inks have poor water resistance, are very susceptible to image blurring, and, when printed on water impermeable recording media such as plastic film, there are drawbacks such as image-forming defects due to low adhesiveness of the ink droplets to the film and the need to prevent the recorded materials being placed on top of one another immediately after printing until the solvent has dried, because of the long drying time of the solvent.

Although solvent-based inks are suitable for printing on water impermeable recording media such as plastic films, there are drawbacks such that an extended period for evaporating the solvent is required and ventilation facilities and a solvent recovery mechanism are also required.

UV-curable inks containing a multifunctional monomer that have superior adhesiveness to the recording medium have been developed for printing on such water impermeable recording media, and inkjet inks have been developed that can form an image by curing the inks by irradiation with radiation rays rather than by vaporization of ink solvent.

Generally, various polymerization-initiating systems have been used for increasing the sensitivity of a radiation-curable polymerizable compound to radiation rays (see, for example, Bruce M. Monroe et al., Chemical Revue, 93 (1993), P. 435-448). Inks containing a polymerizable group-containing a monomer and an oil-soluble dye are also disclosed, for example, in Japanese Patent Application Laid-Open (JP-A) Nos. 2003-221528, 2003-221532, and 2003-221530. Further, a photopolymerizable composition containing a photopolymerizable compound and a photopolymerization initiator is disclosed in JP-A No. 2001-222105. However, polymerization of these UV-curable inks, which are radical-polymerizable, is inhibited by oxygen, easily resulting in insufficient curing in the air, so that further improvement is therefore desirable.

Cationic polymerizable ink compositions are disclosed as systems that are not susceptible to the influence of oxygen. For example, actinic ray-curable compositions containing oxirane and oxetane are disclosed in JP-A Nos. 2000-169552, 2001-220526, and 2002-317139. However, the ink compositions disclosed in these documents have a high viscosity and insufficient curing properties, and thus require a special print head having a higher ejection force, and also require an ultraviolet lamp with high illumination, resulting in the drawback that the size of a printing machine is increased.

Inkjet inks that are used in an inkjet printer are required to have high ejectability. An example of an ink having improved ejectability in an inkjet printer is the ink disclosed in JP-A No. 2001-288387, which contains a liquid resin containing a photoreactive monomer and a colorant, wherein the viscosity of the liquid resin is adjusted so as to be low. However, the ink has drawbacks such as a low sensitivity to light and a tendency to contract when cured.

### SUMMARY OF THE INVENTION

The invention has been made in view of the above circumstances and provides a cationic polymerizable composition, a recorded material, an image forming process, an ink set and an inkjet recording method using the same.

A first aspect of the invention provides a cationic polymerizable composition, comprising at least one oxetane compound containing an unsubstituted methyl group and at least one oxirane compound containing an unsubstituted methyl group.

A second aspect of the invention provides a recorded material prepared by using the cationic polymerizable composition according to the first aspect.

A third aspect of the invention provides a method of forming an image, comprising; applying the cationic polymerizable composition according to the first aspect on a recording medium imagewise; and curing the cationic polymerizable composition applied on the recording medium by irradiation with an actinic ray.

A fourth aspect of the invention provides an inkjet-recording ink set, comprising a liquid A containing at least an image forming polymerizable or crosslinkable material and a second liquid B having a different composition from the liquid A, wherein at least one of the liquids A or B is the cationic polymerizable composition according to the first aspect.

A fifth aspect of the invention provides an inkjet-recording method, comprising recording a desired image on a recording medium by using the ink set according to the fourth aspect, the method further comprising: applying the second liquid B on the recording medium in an area identical to or larger than an image to be formed with the liquid A; and ejecting the liquid A containing an image-forming polymerizable or crosslinkable material at least as a first droplet a1 and a second droplet a2 thereon; wherein the droplets a1 and a2 are ejected to partially overlap.

### DETAILED DESCRIPTION OF THE INVENTION

[Cationic Polymerizable Composition]

The cationic polymerizable composition according to the invention comprises at least one oxetane compound having an unsubstituted methyl group and one oxirane compound having an unsubstituted methyl group, and the composition is cured by irradiation with an actinic ray.

The cationic polymerizable composition in the present invention provides a cationic polymerizable ink composition having a superior curing property and a low viscosity.

Hereinafter, components for the cationic polymerizable composition according to the invention will be described sequentially.

<Oxetane Compound Having Unsubstituted Methyl Group>

The cationic polymerizable composition according to the invention contains an oxetane compound having an unsubstituted methyl group (hereinafter, referred to as “specific oxetane compound” as occasion demands). The specific oxetane compound has at least one or more oxetane rings and an unsubstituted methyl group.

The substitution site of the unsubstituted methyl group in the specific oxetane compound is not particularly limited, but preferably on the oxetane ring, particularly preferably the 3-position to an oxygen atom in the oxetane ring.

The number of the unsubstituted methyl groups in the specific oxetane compound is preferably 1 to 4, particularly preferably 1 to 2, in one molecule.

The number of the oxetane rings in the specific oxetane compound is preferably two or more, more preferably 2 to 4, and particularly preferably, 2 (i.e., bifunctional), from the viewpoint of the viscosity and polymerizable reactivity.

When the specific oxetane compound has two or more oxetane rings, the specific oxetane compound has at least one connecting group connecting the oxetane rings each other and one unsubstituted methyl group.

When the specific oxetane compound has two or more oxetane rings, the connecting group connecting the oxetane rings each other is preferably a chain structural or a cyclic structural connecting group, but is more preferably a chain structural connecting group.

In a bifunctional specific oxetane compound, which is a suitable specific oxetane compound, the connecting group connecting the oxetane rings each other in the chain structure is preferably a group represented by the following Formula (I).

—X-(L)n—Y— Formula (I)

In Formula (I), L represents a divalent connecting group selected from the group consisting of —O—, —S—, and —NR—; and R represents a hydrogen atom or a substituent group. L is preferably —O— or —S—, particularly preferably —O—.

X and Y each independently represent an alkylene group having 1 to 10 carbon atoms, preferably an alkylene group having 1 to 5 carbon atoms, and particularly preferably a methylene group.

In Formula (I), the number of atoms constituting X-L-Y is preferably 3 or 4, more preferably 3.

n is 0 or 1.

The specific oxetane compound may have another substituent, in the case where the substituent can be introduced thereinto, in addition to the connecting groups connecting oxetane rings each other and the unsubstituted methyl group. Examples of the other substituent groups include a vinyl group, an aryl group, an alkoxy group, and an aryloxy group and the like, and these groups may optionally have one or more substituents.

To obtaining a cationic polymerizable composition having a low viscosity, the specific oxetane compound preferably has only two oxetane rings, a divalent connecting group connecting the oxetane rings each other, and unsubstituted methyl groups.

The molecular weight of the specific oxetane compound according to the invention is preferably 150 to 500, more preferably 150 to 300, by weight-average molecular weight.

Specific examples (a) to (f) of the specific oxetane compounds according to the invention are shown below, but are not limited thereto in the invention.

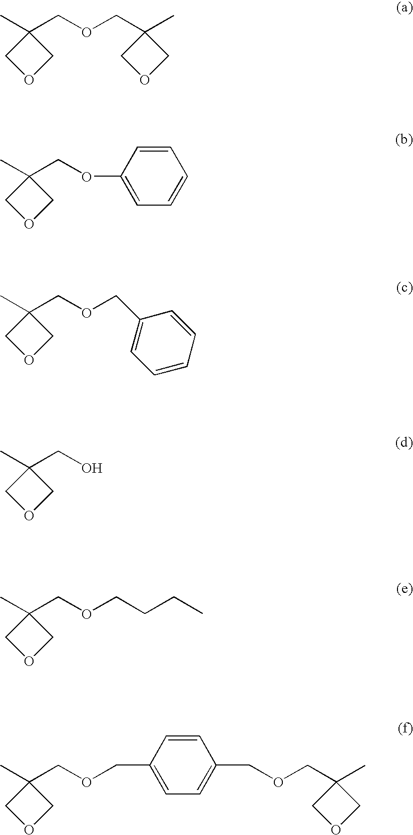

The specific oxetane compounds may be used alone or in combination of two or more. For improvement in flexibility of the cured film, a combination use of a bifunctional particular oxetane compound and a monofunctional particular oxetane compound is also preferable.

The content of the specific oxetane compound is preferably 10 to 90 mass %, more preferably 15 to 80 mass %, and still more preferably 20 to 60 mass %, with respect to the total mass of the cationic polymerizable composition.

<Oxirane Compound Having Unsubstituted Methyl Group>

The cationic polymerizable composition according to the invention contains an oxirane compound having an unsubstituted methyl group (hereinafter, referred to as “specific oxirane compound” as occasion demands). The specific oxirane compound has at least one or more oxirane rings and an unsubstituted methyl group.

The substitution site of the unsubstituted methyl group on the specific oxirane compound is not particularly limited, but preferably on the oxirane ring.

The number of the unsubstituted methyl groups on the specific oxirane compound is preferably 1 to 3, particularly preferably 1 to 2 in one molecule.

The number of the oxirane rings in the specific oxirane compound is preferably two or more, more preferably 2 to 4, particularly preferably 2 (i.e., bifunctional), from the viewpoint of viscosity and polymerizable reactivity.

When the specific oxirane compound has two or more oxirane rings, the specific oxirane compound has at least one connecting groups connecting the oxirane rings each other and one unsubstituted methyl group.

When the specific oxetane compound has two or more oxirane rings, the connecting group connecting the oxirane rings each other may preferably be either a chain structural connecting group or a cyclic structural connecting group.

In a bifunctional specific oxirane compound, which is a preferable specific oxirane compound, the chain structural connecting group connecting the oxirane rings each other is preferably an alkylene group or a group represented by the Formula (I).

When the chain structural connecting group is an alkylene group, an alkylene group having 1 to 10 carbon atoms is preferred, more preferably an alkylene group having 1 to 5 carbon atoms is preferred, and particularly preferably an alkylene group having 1 to 3 carbon atoms is preferred.

The cyclic structural connecting group connecting oxirane rings each other may preferably be either an aromatic ring or aliphatic ring. Preferable examples of the aromatic rings include, but are not limited to, benzene, naphthalene and anthracene rings and the like. Preferable examples of the aliphatic rings include, but are not limited to, cyclohexane, cyclohexene, cyclooctane, norbornane, and the like. The bonding form between the cyclic structural connecting group and the oxirane ring is, for example, a condensed-ring bond a single bond or a spiro bond, and, when there are plural oxirane rings in the same molecule, different bonding structures between the rings may also preferably be preferred.

The specific oxirane compound may have another substituent group in addition to, in the case where the substituent group can be introduced thereinto, the connecting groups connecting the oxirane rings each other and the unsubstituted methyl groups. Examples of the other substituent groups include a vinyl group, an aryl group, an alkoxy group, and an aryloxy group and the like, and these groups may further have one or more substituents groups.

To obtaining a cationic polymerizable composition having a low viscosity, the specific oxetane compound preferably has only two oxetane rings, a divalent connecting group connecting the oxetane rings, and an unsubstituted methyl group, and preferably, the oxirane rings are bounded to the cyclic connecting group by a condensed-ring or by a chemical bond.

The molecular weight of the oxirane compound according to the invention is preferably 150 to 500, more preferably 150 to 300, by weight-average molecular weight.

Specific examples of the specific oxirane compounds according to the invention (ME-1 to ME-6) are shown below, but are not limited thereto in the invention.

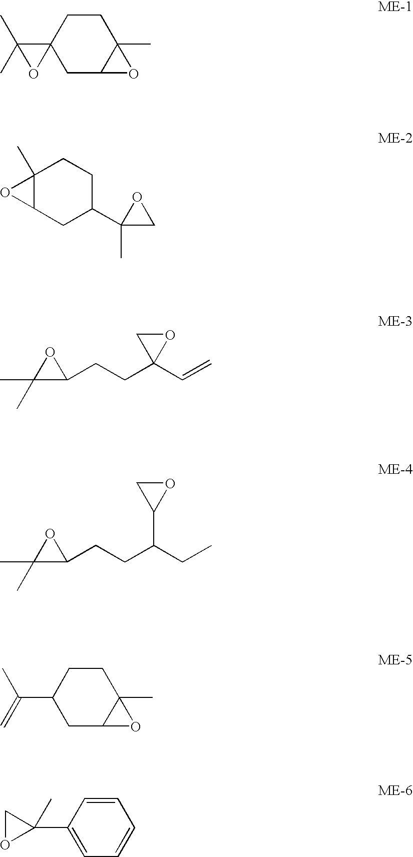

The specific oxirane compounds may be used either one kind alone or two or more kinds in combination.

The content of the specific oxirane compound in the cationic polymerizable composition is preferably 10 to 70 mass %, more preferably 15 to 55 mass %, and still more preferably 20 to 45 mass %, with respect to the total mass of the cationic polymerizable composition.

The mass ratio of the specific oxirane compound to the specific oxetane compound is preferably 0.1 to 5, more preferably 0.2 to 3.0, and particularly preferably 0.3 to 1.0.

<Other Polymerizable Compound>

The cationic polymerizable composition in the invention preferably contains a monofunctional polymerizable compound other than the specific oxetane compound and specific oxirane compound, from the viewpoint of the flexibility of the film after curing of the composition. The monofunctional polymerizable compound is preferably a monofunctional oxirane or oxetane compound. Examples of the monofunctional polymerizable compounds include the compounds (A-1) to (A-9) are shown below.

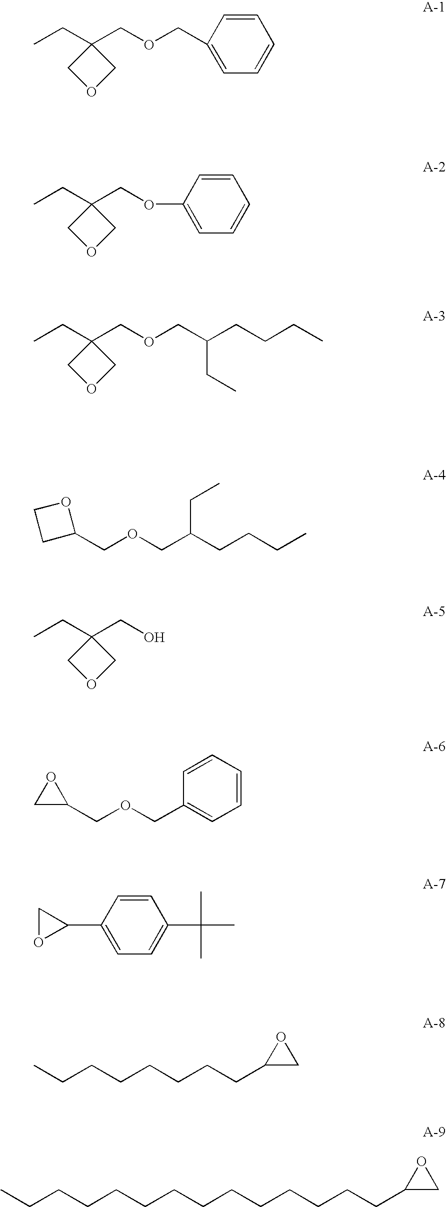

The other polymerizable compounds may be used either one kind alone or two or more kinds in combination.

The other polymerizable compound is preferably contained in an amount of 0 to 900 mass %, more preferably 30 to 400 mass %, with respect to the specific oxetane and specific oxirane compounds.

The ratio of the number of all oxirane rings to the number of all oxetane rings present in the cationic polymerizable composition according to the invention is preferably 0.1 to 10, more preferably 0.2 to 5, still more preferably 0.5 to 2, and particularly preferably 0.8 to 1.2.

<Polymerization Initiator>

The cationic polymerizable composition according to the invention preferably contains a polymerization initiator.

The polymerization initiator is preferably, for example, a photopolymerization initiator that generates an acid by the actinic ray. The photopolymerization initiator has an absorption in the wavelength region of the actinic ray and acts on the polymerizable compounds described above to accelerate polymerization and curing when exposed to the actinic ray. The light-acid generating agent is a compound which causes a chemical change to generate an acid by the action of the actinic ray or by interaction with the electron-excited state of a sensitizer described below. The actinic ray to which the invention is used for will be described below.

Any compound may be used as the photopolymerization initiator (light-acid generating agent), and many preferable examples thereof are described in Bruce M. Monroe et al., Chemical Revue, 93, 435 (1993); R. S, Davidson, Journal of Photochemistry and biology A: Chemistry, 73. 81 (1993); J. P. Faussier “Photoinitiated Polymerization—Theory and Applications”: Rapra Review vol. 9, Report, Rapra Technology (1998); and M. Tsunooka et al., Prog. Polym. Sci., 21, 1 (1996). Further, many chemically amplifying photoresists and compounds used in photocationic polymerization are described in (Japanese Research Association for Organic Electronics Materials Ed., “Organic Materials for Imaging”, Bun-Shin Shuppan (1993), p. 187 to 192). Also known are the compound groups that cause bond cleavage oxidatively or reductively through interaction with the excited electronic state of a sensitizing dye, as described in F. D. Saeva, Topics in Current Chemistry, 156, 59 (1990); G. G. Maslak, Topics in Current Chemistry, 168, 1 (1993); H. B. Shuster et al., JACS, 112, 6329 (1990); I. D. F. Eaton et al., JACS, 102, 3298 (1980); and others.

Commercially available compounds may also be used, and examples thereof include lrgacure 250 and 1870 from Ciba Specialty Chemicals (both products are trade names), and the like.

Preferable photopolymerization initiators include (a) aromatic ketones, (b) aromatic onium salt compounds, (c) organic peroxides, (d) hexaarylbiimidazole compounds, (e) ketoxime ester compounds, (f) borate compounds, (g) azinium compounds, (h) metallocene compounds, (i) active ester compounds, 0) carbon halogen bond-containing compounds, and the like.

In the invention, using (4-isobutylphenyl) phenyliodonium hexafluorophosphate is preferable, particularly in a form dissolved in propylene carbonate.

The use of a mixture of two or more such iodonium salt photoinitiators as the composition according to the invention is also preferable.

The cationic polymerizable composition according to the invention preferably contains a (a) triarylsulfonium salt polymerization initiator containing one or more aryl skeleton having an electron attracting group as its substituent group (hereinafter, referred to as a “specific polymerization initiator” as occasion demands).

The specific polymerization initiator is particularly preferably a polymerization initiator having a triarylsulfonium salt structure and having a sum of Hammett values of the substituent groups binding to the aryl skeleton is more than 0.46.

—Triarylsulfonium Salt Structure—

The compounds having the triarylsulfonium salt structure can easily be prepared according to the methods described, for example, in J. Amer. Chem. Soc. 112 (16), 1990, pp. 6004-6015; J. Org. Chem. 1988, pp. 5571-5573; WO 02/081439A1; and Specification of EP Patent No. 1113005.

—Substituent Groups Binding to the Aryl Skeleton—

The particular polymerization initiator contains one or more aryl skeletons having an nucleophilic group as its substituent group. The nucleophilic group means a substituent group having a Hammett value (Hammett substituent group constant c) greater than 0. In the invention, sum of Hammett values of the substituent groups bounded to the aryl skeleton in the specific polymerization initiator is preferably 0.18 or more, more preferably 0.46 or more, and still more preferably 0.60 or more for achiving a high sensitivity.

The Hammett value represents the degree of an electron attraction of a cation having the triarylsulfonium salt structure; and there is no upper limit from the viewpoint of improving the sensitivity, however it is preferably in the range of 0.46 or more and less than 4.0, more preferably 0.50 or more and less than 3.5, and particularly preferably 0.60 or more and less than 3.0, from the viewpoint of reactivity and stability. The numerical values described in Naoki Inamoto Ed., Chemistry Seminar 10: Hammett Equation—Structure and Reactivity—(1983, published by Maruzen Co., Ltd.) are used as the Hammett values in the invention.

The content of the polymerization initiator in the cationic polymerizable composition is preferably in the range of 2 to 12 mass %, more preferably in the range of 3 to 6 mass %, with respect to the total mass of the specific oxetane compound, the specific oxirane compound, and other polymerizable compounds used as occasion demands. It is possible to obtain sufficient polymerization and curing effects, by adjusting the content of polymerization initiator to the range described above.

<Sensitizer>

In addition, the cationic polymerizable composition according to the invention may further contain a sensitizer for accelerating polymerization and curing. The sensitizer is, for example, an anthracene that may have a substituent group.

When the anthracene has a substituent group, examples of the substituent group include an alkyl group, an alkoxy group, an aryloxy group and the like, and among them, an alkoxy group having 1 to 4 carbon atoms are preferable. The number of the substituents on the anthracene is preferably 1 to 4, more preferably 1 to 2. In particular, the substitution site of the substituent is preferably the 9-position when the anthracene is mono-substituted, and the substitution sites are preferably 9- and 10-positions when it is di-substituted. In particular, 9- or 10-substituted anthracene compound is preferable, when it is di-substituted.

The content of the sensitizer in the cationic polymerizable composition according to the invention is preferably 35 to 100 mass %, more preferably 40 to 80 mass %, and still more preferably 44 to 75 mass %, with respect to the polymerization initiator. The preferred content of the polymerization initiator described above and the preferred content of the anthracene compound are preferably satisfied simultaneously.

<Surfactant>

The cationic polymerizable composition according to the invention preferably contains a known surfactant. Examples of known surfactants include those described in JP-A Nos. 62-173463 and 62-183457. Specific examples thereof include anionic surfactants such as dialkyl sulfoscuccinate salts, alkylnaphthalenesulfonate salts, and fatty acid salts; nonionic surfactants such as polyoxyethylene alkylethers, polyoxyethylene alkylallylethers, acetylene glycols, and polyoxyethylene-polyoxypropylene block copolymers; and cationic surfactants such as alkylamine salts and quaternary ammonium salts. An organic fluorocompound may be used instead of the known surfactants. The organic fluorocompound is preferably hydrophobic. Examples of the organic fluorocompounds include fluorine-based surfactants, oily fluorine based compounds (e.g., fluorine oil) and solid fluoro-resins (e.g., tetrafluoroethylene resin); and specific examples thereof include those described in Japanese Patent Application Publication (JP-B) No. 57-9053 (Columns 8 to 17) and JP-A No. 62-135826.

<Colorant>

In addition, the cationic polymerizable composition according to the invention may further contain a colorant, if coloration is necessary. Inclusion of a colorant in the cationic polymerizable composition according to the invention, for example, to enables the composition to form a visible image and the like.

The colorant for use in the cationic polymerizable composition according to the invention is not particularly limited, and applications can be selected from various known colorants (pigments and dyes) and used depending on the purpose. For example, use of a pigment is preferable when forming an image having a high weather-fastness. A water-soluble or oil-soluble dye may be used as the dye, however an oil-soluble dye is preferable.

—Pigment—

First, pigments which can be preferably used as the colorant in the invention will be described.

The pigment is not particularly limited, and any one of common commercially available pigments, including organic and inorganic pigments, pigment dispersions the pigment dispersed in an insoluble resin or the like and pigments having a graft resin on the surface thereof, may be used. In addition, resin particles dyed with a dyestuff may also be used.

Such pigments include the pigments described, for example, in Seijiro Itoh Ed., “Dictionary of Pigments” (2000), W. Herbst K. Hunger, “Industrial Organic Pigments”, and JP-A Nos. 2002-12607, 2002-188025, 2003-26978, and 2003-342503.

Specific examples of the organic and inorganic pigments for use in the invention include: yellow pigments including monoazo pigments such as C.I. Pigment Yellow 1 (Fast Yellow G, etc.) and C.I. Pigment Yellow 74, disazo pigments such as C.I. Pigment Yellow 12 (Disazo Yellow AAA, etc.) and C.I. Pigment Yellow 17, non-benzidine azo pigments such as C.I. Pigment Yellow 180, azolake pigments such as C.I. Pigment Yellow 100 (tartrazine yellow lake, etc.), condensation azo pigments such as C.I. Pigment Yellow 128, C.I. Pigment Yellow 93, and C.I. Pigment Yellow 95 (condensation azo yellow GR, etc.), acidic dye lake pigments such as C.I. Pigment Yellow 115 (quinoline yellow lake, etc.), basic dye lake pigments such as C.I. Pigment Yellow 18 (thioflavin lake, etc.), anthraquinone-based pigments such as fravantrone yellow (Y-24), isoindolinone pigments such as isoindolinone yellow 3RLT (Y-110), quinophtharone pigments such as quinophtharone yellow (Y-138), isoindoline pigments such as isoindoline yellow (Y-139), nitroso pigments such as C.I. Pigment Yellow 153 (nickel nitroso yellow, etc.), metal complex salt azomethine pigments such as C.I. Pigment Yellow 117 (copper azomethine yellow, etc.), and the like;

red or magenta pigments including monoazo-based pigments such as C.I. Pigment Red 3 (toluidine red, etc.), disazo pigments such as C.I. pigment red 38 (pyrazolone red B, etc.), azolake pigments such as C.I. Pigment Red 53:1 (lake red C, etc.) and C.I. Pigment Red 57:1 (Brilliant Carmine 6B), condensation azo pigments such as C.I. Pigment Red 144 (condensation azo red BR, etc.), acidic dye lake pigments such as C.I. Pigment Red 174 (phloxine B lake, etc.), basic dye lake pigments such as C.I. Pigment Red 81 (rhodamine 6G′ lake, etc.), anthraquinone pigments such as C.I. Pigment Red 177 (dianthraquinonyl red, etc.), thioindigo pigments such as C.I. Pigment Red 88 (Thioindigo Bordeaux, etc.), perynone pigments such as C.I. Pigment Red 194 (perynone red, etc.), perylene pigments such as C.I. pigment red 149 (perylene scarlet, etc.), quinacridone pigments such as C.I. Pigment Violet 19 (unsubstituted quinacridone) and C.I. Pigment Red 122 (quinacridone magenta, etc.), isoindolinone pigments such as C.I. Pigment Red 180 (isoindolinone red 2BLT, etc.), alizarin lake pigments such as C.I. Pigment Red 83 (madder lake, etc.), and the like;

blue or cyan pigment including disazo-based pigments such as C.I. Pigment Blue 25 (dianisidine blue, etc.), phthalocyanine pigments such as C.I. Pigment Blue 15 (phthalocyanine blue, etc.), acidic dye lake pigments such as C.I. Pigment Blue 24 (peacock blue lake, etc.), basic dye lake pigments such as C.I. Pigment Blue 1 (Victria Pure Blue BO lake, etc.), anthraquinone-based pigments such as C.I. Pigment Blue 60 (indanthron blue, etc.), alkali blue pigments such as C.I. Pigment Blue 18 (alkali Blue V-5:1), and the like;

green pigments including phthalocyanine pigments such as C.I. Pigment green 7 (phthalocyanine green) and C.I. Pigment green 36 (phthalocyanine green), azo metal complex pigments such as C.I. Pigment green 8 (nitroso green), and the like; orange pigments including isoindoline-based pigments such as C.I. Pigment orange 66 (isoindoline orange) and anthraquinone-based pigments such as C.I. Pigment orange 51 (dichloropyranthron orange); and

black pigments such as carbon black, titanium black, aniline black and the like.

Specific examples of the white pigments include basic carbonate white lead (2PbCO₃Pb(OH)₂, so-called silver white), zinc oxide (ZnO, so-called zinc white), titanium oxide (TiO₂, so-called titanium white), strontium titanate (SrTiO₃, so-called titanium strontium white), and the like.

Titanium oxide has a refractive index higher than that of other white pigments, is more stable chemically or physically, and thus, has a greater covering power and coloring power as a pigment, and has an excellent resistance to acid or alkali and other environmental factors. Thus, use of titanium oxide as the white pigment is preferable. Other white pigments (including white pigments other than those described above) may be used, if necessary.

To dispersing the pigment, any one of dispersing machines, such as a ball mill, sand mill, attriter, roll mill, jet mill, homogenizer, paint shaker, kneader, agitator, Henschel mixer, colloid mill, ultrasonic wave homogenizer, pearl mill, and wet jet mill, may be used.

The volume average particle diameter of the pigment particles in cationic polymerizable composition is preferably 0.02 to 0.60 μm, more preferably 0.02 to 0.15 μm. However, the volume average particle diameter of the white pigment is preferably 0.10 to 0.27 μm. The maximum diameter is preferably 3 μm or less, more preferably 1 μm or less, and thus, the pigment, the dispersant, and the dispersion medium are selected and the dispersion and filtration conditions are determined so as to be within the above range.

By controlling the particle diameter as described above, it is possible to prevent the head nozzle clogging and maintain the ink storability, ink transparency and curing sensitivity, for example, when the cationic polymerizable composition is used as an inkjet-recording ink in a preferred embodiment.

<Dispersant>

A dispersant may be added during dispersion of the pigment. Examples of the dispersants include hydroxyl group-containing carboxylic acid esters, salts of a long-chain polyaminoamide with a high-molecular-weight acid ester, high-molecular-weight polycarboxylic acid salts, high-molecular-weight unsaturated acid esters, high-molecular-weight copolymers, modified polyacrylates, polyvalent aliphatic carboxylic acids, naphthalenesulfonic acid/formalin condensates, polyoxyethylene alkylphosphoric esters, pigment derivatives, and the like. Use of a commercially available polymer dispersant such as a Solsperse series product manufactured by Lubrizol is also preferable.

Examples of the dispersants used particularly preferably in the invention include polymers having a repeating unit represented by the following Formula (II).

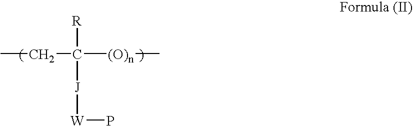

In Formula (II), R represents a hydrogen atom or a methyl group. J represents —CO—, —COO—, —CONR¹—, —OCO—, a methylene group, or a phenylene group; and R¹ represents a hydrogen atom or an alkyl, aryl, or aralkyl group. W represents a single bond or a divalent connecting group. P represents a colorant-forming heterocyclic moiety. n is 0 or 1.

In Formula (II), P is preferably selected from quinacridone, benzimidazolone, indole, quinoline, carbazole, acridine, acridone, and anthraquinone.

The polymer containing the repeating unit represented by Formula (II) is preferably a graft copolymer having a repeating unit derived from a polymerizable oligomer (macromonomer) having ethylenic unsaturated double bonds at the terminals as a copolymerization unit.

A synergist suitable for the various pigments may be used as dispersion aid. The dispersant and dispersion aid are preferably added in an amount of 1 to 50 parts by mass with respect to 100 parts by mass of the pigment.

A solvent may be added to the cationic polymerizable composition according to the invention as a dispersion medium for various components such as pigment, or alternatively, the above polymerizable compound, as a low-molecular-weight component, may be used as the dispersion medium while no solvent is added; but, when the cationic polymerizable composition according to the invention is used as an radiation curable ink, no solvent is preferably used for ejecting and curing the ink on a recording medium. It is because the solvent remaining in cured ink image leads to deterioration thereof in solvent resistance and problems due to residual volatile organic compounds (VOCs). From the viewpoint above, the polymerizable compound is preferably used as the dispersion medium, and selection of a polymerizable compound having the lowest viscosity is particularly preferable for improvement in dispersibility and processability of the composition.

<Other Components>

The cationic polymerizable composition according to the invention may contain other components, if necessary, in addition to the components described above. Examples of the other components include known additives such as a storage stabilizer, electro-conductive salt, polymer, surface tension adjuster, ultraviolet absorbent, antioxidant, decoloration inhibitor, and pH adjuster.

—Favorable Physical Properties of Cationic Polymerizable Composition—

The viscosity of the cationic polymerizable composition according to the invention is preferably 3 to 35 mPa·s at 25° C., more preferably 5 to 25 mPa·s, and particularly preferably 7 to 15 mPa·s.

The viscosity in the present specification is a viscosity measured by using RE80 viscometer (manufactured by Toki Sangyo Co., Ltd.) at a liquid temperature of 25° C.

The surface tension of the cationic polymerizable composition according to the invention is preferably 24 to 35 mN/m, particularly preferably 25 to 30 mN/m at 25° C.

The surface tension in the present specification is a surface tension measured by using an automatic surface tension balance CBVP-Z (manufactured by Kyowa Interface Science Co., Ltd.) at a liquid temperature of 25° C.

The cationic polymerizable composition according to the invention is useful, for example, as an image-forming ink composition for use in a UV-curable ink, paint, adhesive agent, and the like.

In particular, the cationic polymerizable composition according to the invention is preferably used as an inkjet ink composition. Such an inkjet ink composition, which has a superior curing property and lower viscosity, is advantageous for allowing to cure the composition at a practical speed even when a light-emitting diode (LED) or a semiconductor laser is used as an irradiation light source and the composition can be ejected through commonly-used ink heads having a lower ejecting force, while a favorable defect-free image is formed.

[Recorded Material]

The recorded material according to the invention is prepared by using the cationic polymerizable composition according to the invention that has a superior curing property of an image region formed on a recording medium.

[Image-Forming Process]

The image-forming process according to the invention includes a step of applying imagewisely the cationic polymerizable composition according to the invention described above onto a recording medium and a step of curing the cationic polymerizable composition formed on the recording medium by irradiation with an actinic ray.

In the image-forming process according to the invention, the cationic polymerizable composition is irradiated with an actinic ray within a period for 0.001 to 1 second after the cationic polymerizable composition is imagewisely applied onto a recording medium so that polymerization and curing of the polymerizable compound are accelerated to form a suitably cured image.

In the application step above, the cationic polymerizable composition may be applied onto a recording medium in any way, for example, by coating in a coating machine or by ejecting the composition from an inkjet nozzle.

Preferable examples of inkjet-nozzle ejection methods (inkjet-recording methods) include known methods such as a charge control method which uses electrostatic attraction to eject ink, a drop-on-demand method (pressure pulse method) which uses vibration pressure of a piezo element, an acoustic ink jet method in which an electric signal is transformed into an acoustic beam and ink is irradiated with the acoustic beam so as to be ejected by radiation pressure, and a thermal ink jet (Bubble Jet®) method which uses pressure caused by bubbles formed by heating ink.

Examples of the ink jet recording method include a method which uses ink having low concentration called photo ink to eject a multitude of ink droplets having a small volume, a method which uses a plurality of inks having substantially the same color hue but different concentrations to improve image quality, and a method which uses colorless transparent ink.

The actinic ray may be applied favorably by irradiating with an actinic ray. Examples of the actinic rays include an ultraviolet ray, visible ray, alpha ray, y ray, X ray, electron beam, and the like. Among them, use of ultraviolet or visible ray is preferable from the viewpoint of cost and safety, and use of ultraviolet ray is particularly preferable.

Specific examples of the light sources for the actinic ray include a LD, light-emitting diode (LED), semiconductor laser, fluorescent lamp, low-pressure mercury lamp, high-pressure mercury lamp, metal halide lamp, carbon arc lamp, xenon lamp, chemical lamp, and the like.

Preferred light sources include an LED, semiconductor laser, high-pressure mercury lamp, and metal halide lamp. In particular in the invention, it is possible to obtain a superior cured image, when the LED or semiconductor laser is used as the irradiation light source.

The energy needed for the curing reaction may vary according to the kind and content of the polymerization initiator used, but is generally about 1 to 500 mJ/cm².

### —Recording Medium—

As the recording medium, an impermeable or slowly-permeable recording medium is used.

Examples of the impermeable recording medium include synthetic resins, rubber, resin coated paper, glass, metal, ceramic, and wood. Furthermore, these materials may be used in combination of two or more as composite substrates for the purpose of adding functions.

As the above-described synthetic resin, any synthesis resins may be used. Examples thereof include polyester such as polyethylene terephthalate, and polybutadiene terephthalate, polyolefin such as polyvinyl chloride, polystyrene, polyethylene, polyurethane, and polypropylene, acrylic resin, polycarbonate, acrylonitrile-butadiene-styrene copolymer, diacetate, triacetate, polyimide, cellophane, and celluloid. The thickness and shape of these synthesis resins are not particularly limited, and the shape may be either film, card, or block form. Furthermore, the resins may be either transparent or opaque.

The above-described synthesis resin is preferably used in film form which is suitable for so-called soft packaging, and examples thereof include various non-absorbing plastics and films thereof. Examples of the plastic film include a PET film, an OPS film, an OPP film, a PNy film, a PVC film, a PE film, and a TAC film. Other examples of the plastics include polycarbonate, acrylic resin, ABS, polyacetal, PVA, and rubbers.

Examples of the above-described resin coated paper include a transparent polyester film, an opaque polyester film, an opaque polyolefin resin film, and a paper support laminated with a polyolefin resin on both sides. Among them, a paper support laminated with a polyolefin resin on both side surfaces is most preferable.

The above-described metal is not particularly limited, and preferable examples thereof include aluminum, iron, gold, silver, copper, nickel, titanium, chromium, molybdenum, silicon, lead, zinc, stainless steel, and composite materials thereof.

Furthermore, read-only optical disks such as CD-ROM and DVD-ROM, write-once optical disks such as CD-R and DVD-R, and re-writable optical disks can be used, and an ink receiving layer and a brightening layer may be added to the label surface.

[Inkjet-Recording Ink Set and Inkjet-Recording Method]

The cationic polymerizable composition according to the invention is preferably used as an inkjet ink composition as described above.

Hereinafter, preferably embodiments of the inkjet-recording ink set using the cationic polymerizable composition according to the invention and the inkjet-recording method using the ink set will be described.

The ink set according to the invention is an ink set including a liquid A containing at least an image-forming polymerizable or crosslinkable material and a second liquid B having a composition different from the liquid A, wherein at least one of the liquids A and B is the cationic polymerizable composition according to the invention.

The inkjet-recording method according to the invention is an inkjet-recording method of recording a desired image on a recording medium by ejecting at least a first droplet a1 and a second droplet a2 of the liquid A containing an image-forming polymerizable or crosslinkable material in the ink set according to the invention, wherein the droplets a1 and a2 are ejected such that the droplets are partilly overlapped, after the second liquid B having a composition different from that of the liquid A is applied previously onto an area identical with or larger than the image area formed with the liquid A on the recording medium.

In the ink set according to the invention, only one or both of the liquids A and B may be the cationic polymerizable composition according to the invention, and both of the liquids A and B are preferably the cationic polymerizable composition according to the invention, from the viewpoint of curing property and film strength.

When the cationic polymerizable composition according to the invention is used as the liquid A and/or the liquid B in the ink set according to the invention, the liquid A and/or the liquid B contains the specific oxetane compound and specific oxirane compound as a polymerizable material and, if necessary, a colorant, may further contains a polymerization initiator, a sensitizer, and other components additionally.

Components for use in the liquid A and/or the liquid B are the same as those used for the cationic polymerizable composition according to the invention described above.

When both liquids A and B are the cationic polymerizable composition according to the invention, the both liquids are prepared in different compositions. For example, the liquid compositions may be made different from each other, for example, by adding a colorant only to liquid A, adding an initiator only to liquid B, or adding a surfactant to liquid B in an amount larger than the amount to be added to liquid A.

Preferably, the liquid B has an SP (solubility parameter) value of 35 or less, and the difference in SP value between the liquids A and B is 10 or less.

When the ink set according to the invention is used in the inkjet-recording method according to the invention, a liquid B having an SP value of 35 or less leads to increase in affinity to the first liquids A (droplet a1, droplet a2 . . . ) and prevents coalescence of the droplets a1 and a2 when ejected as partially overlapped each other, so that image blurring and variation of line width of thin line in an image effectively be prevented.

The SP value of liquid B is more preferably 30 or less, particularly preferably 25 or less. The difference in SP value between the first liquid A and second liquid B is more preferably 5 or less.

When the difference in SP value between the liquids A and B is in the range above, the liquids are more compatible with each other, and the droplet a1, which is in contact with the droplet B in a contact area larger than that with the droplet a2, has a greater affinity to the second liquid B; and thus, for example, when the droplets a1, a2, and so forth that are ejected as the droplets are mutually partially overlapped on each other, contain a colorant, color blurring or color mixing between droplets a1 and a2 and also fluctuation in line width of the colored line images can effectively be prevented.

The SP value may be adjusted favorably by using an oleophilic solvent.

Examples of the kinds of and the preparative methods for the oleophilic solvent are described, for example, in U.S. Pat. Nos. 2,322,027, 2,533,514, 2,772,163, 2,835,579, 3,594,171, 3,676,137, 3,689,271, 3,700,454, 3,748,141, 3,764,336, 3,765,897, 3,912,515, 3,936,303, 4,004,928, 4,080,209, 4,127,413, 4,193,802, 4,207,393, 4,220,711, 4,239,851, 4,278,757, 4,353,979, 4,363,873, 4,430,421, 4,430,422, 4,464,464, 4,483,918, 4,540,657, 4,684,606, 4,728,599, 4,745,049, 4,935,321, and 5,013,639; EP Patent Nos. 276,319A, 286,253A, 289,820A, 309,158A, 309,159A, 309,160A, 509,311A, and 510,576A; East Germany Patent Nos. 147,009, 157, 147, 159,573, and 225,240A; British Patent No. 2,091,124A; and JP-A Nos. 48-47335, 50-26530, 51-25133, 51-26036, 51-27921, 51-27922, 51-149028, 52-46816, 53-1520, 53-1521, 53-15127, 53-146622, 54-91325, 54-106228, 54-118246, 55-59464, 56-64333, 56-81836, 59-204041, 61-84641, 62-118345, 62-247364, 63-167357, 63-214744, 63-301941, 64-9452, 64-9454, 64-68745, 1-101543, 1-102454, 2-792, 2-4239, 2-43541, 4-29237, 4-30165, 4-232946, and 4-346338; and others.

In a preferable preparative embodiment, the oleophilic solvent is added in an amount in the range of 50 mass % or more and 100 mass % or less in the total mass of the liquid B.

Addition of the oleophilic solvent is effective for preventing image occurrence of blurring and line-width fluctuation of thin lines in an image and also for adjusting the SP value of the liquid B in the range above. The “oleophilic” compound is a compound having a solubility of 1 g or less in 100 mL of water.

The oleophilic solvent may be added to the liquid A above, with or without addition of the oleophilic solvent to the liquid B.

Such oleophilic solvents include a high-boiling-point organic solvent, polymer material, and the like, and the high-boiling-point organic solvent is preferable. Preferable examples of the high-boiling-point organic solvent include the high-boiling-point solvents described in JP-A Nos. 2004-101959, 2004-123838, 2004-175874, 2006-36932, and 2005-289362.

The SP value, which is defined for a solvent and solute, is a value indicating the compatibility between a solvent and a solvent or between a solvent and a solute. The value is calculated on the basis of change of energy when a solvent and another solvent is miscible, or a solute is dissolved in a solvent, and specifically, the SP values used in the invention are those obtained by using the SP value-calculating program developed by R. L. smith, Tohoku Univ. In calculation, it is assumed that: the reference temperature is 25° C.; a polymer or a polyethylene chain and the like has a saturated repeating unit having two binding sites (e.g., —CH₂—CH(C₆H₅)— in the case of styrene) as its constituent unit, except for compounds having no carbon atom; and water (H₂O) has a SP value of 47.8.

When the polymerizable composition according to the invention is used only in one of the liquids A and B, preferable examples of the other liquid constituting the ink set together with the cationic polymerizable composition according to the invention include the polymerizable compound-containing liquids described, for example, in JP-A Nos. 11-231120, 2005-67138, 2005-74904, 2005-111836, 2005-178294, 2005-254521, 2006-28405, and 2006-160916, and others.

In the inkjet-recording method according to the invention, a desired image is formed by ejecting droplets a1, a2, and so forth of the first liquid A from an ink ejection nozzle (head) of inkjet printer onto a non-permeable to low-permeable recording medium by using the ink set according to the invention above. The first liquid A contains at least a polymerizable or crosslinkable material to form a desired image, and, in forming a high-density image, a second liquid B having a different composition from that of the liquid A is applied onto the area of the recording medium identical with or larger than the area of the desired image before the first droplet a1 and the droplet a2 are ejected such that the first droplet a1 and the droplet a2 are partially overlapped each other.

In the inkjet-recording method according to the invention, a non-permeable to low-permeable recording medium is used as the recording medium. When an image is recorded on such a less liquid-absorbing recording medium, adjuscent droplets ejected as the droplets are mutually partially overlapped each other (first droplet a1 and droplet a2) for obtaining a high-density image, often become in contact to coalesce each other on the medium before drying, resulting in image blurring and fluctuation in width of the thin lines to impair formation of sharp image. However, it is possible to prevent coalescence of the droplets a1 and a2 even when the droplets a1 and a2 are ejected as the droplets are mutually partially overlapped and also to prevent image blurring and line width variation of thin lines in image effectively, by applying the liquid B previously before the ejection of the first droplet a1 and the droplet a2, and thus, it is possible to record a high-quality image by forming sharp uniform-width lines while a high-density image having a high resolution is maintained. The image is also less tacky and has superior abrasion resistance.

The impermeable recording medium refers to a medium which is substantially impermeable to droplets. “Substantially impermeable” means that the permeation rate measured one minutes after ink deposition is 5% or less. The slowly-permeable recording medium refers to a medium on which the complete permeation of 10 μl (picoliter) of droplets takes 100 m seconds or more, and specific examples thereof include art paper. The non-permeable to low permeable recording media are described above. Permeable recording medium refers to a medium on which the complete permeation of 10 μl of droplets takes 100 m seconds or less, and specific examples thereof include plain paper and porous paper.

After ejection of the first droplet a1 onto the recording medium, the following first droplet a2 is ejected so as to partially overlap the droplet a2 on the droplet a1. A second liquid B having different composition from that of the first liquid A is applied on the area of the recording medium identical with or larger than the image area formed with the droplets a1 and a2 previously before ejection of the first droplet a1 and the droplet a2.

In the present invention, as the liquids for forming an image, the first liquid A containing the first droplet a1 and droplet a2, and the second liquid B having a composition different from that of the first liquid A are used. The first droplet a1 and droplet a2 refer to the droplets among the droplets a1, a2, a3, . . . , and ax of a single first liquid A, which are ejected from an ink ejecting port and overlappedly jetted. The droplets may be simultaneously jetted droplets, or sequentially jetted preceding and subsequent droplets, and are preferably sequentially jetted preceding and subsequent droplets. The first liquid A and the second liquid B have different compositions.

As described above, use of a liquid B having an SP value in the range above is preferable in the invention.

In the inkjet-recording method according to the invention, the first droplet a1 and the droplet a2 described above may be ejected, for example, from an inkjet nozzle and the like, however the second liquid B may not be restricted to ejection through an inkjet nozzle and may be applied by other means such as coating and the like.

Hereinafter, exemplifying aspects and embodiments of the invention will be described.

(1) A first embodiment is a cationic polymerizable composition, comprising at least one oxetane compound containing an unsubstituted methyl group and at least one oxirane compound containing an unsubstituted methyl group.

(2) A second embodiment is the cationic polymerizable composition according to the first embodiment, wherein the at least one oxirane compound containing an unsubstituted methyl group has two or more oxirane rings.

(3) A third embodiment is the cationic polymerizable composition according to the first embodiment, wherein the at least one oxetane compound containing an unsubstituted methyl group has two or more oxetane rings.

(4) A fourth embodiment is the cationic polymerizable composition according to the second embodiment, wherein the at least one oxetane compound containing an unsubstituted methyl group has two or more oxetane rings.

(5) A fifth embodiment is the cationic polymerizable composition according to the first embodiment, further comprising a monofunctional oxirane compound and/or a monofunctional oxetane compound other than the at least one oxetane compound containing an unsubstituted methyl group and the at least one oxirane compound containing an unsubstituted methyl group.

(6) A sixth embodiment is the cationic polymerizable composition according to the first embodiment, further comprising a colorant.

(7) A seventh embodiment is the cationic polymerizable composition according to the sixth embodiment, wherein the colorant is a pigment.

(8) An eighth embodiment is the cationic polymerizable composition according to the sixth embodiment, wherein the colorant is an oil-soluble dye.

(9) A ninth embodiment is the cationic polymerizable composition according to the first embodiment, further comprising a polymerization initiator.

(10) A tenth embodiment is the cationic polymerizable composition according to the first embodiment, wherein further comprising a sensitizer.

(11) An eleventh embodiment is the cationic polymerizable composition according to the first embodiment, for use in image formation.

(12) A twelfth embodiment is a recorded material, prepared by using the cationic polymerizable composition according to the first embodiment.

(13) A thirteenth embodiment is a method of forming an image, comprising:

applying the cationic polymerizable composition according to the first embodiment on a recording medium imagewise; and

curing the cationic polymerizable composition applied on the recording medium by irradiation with an actinic ray.

(14) A fourteenth embodiment is the method of forming an image according to the thirteenth embodiment, wherein the cationic polymerizable composition is ejected from an inkjet nozzle during the application.

(15) A fifteenth embodiment is the method of forming an image according to the thirteenth embodiment, wherein the irradiation light source of the actinic ray is a light-emitting diode or a semiconductor laser.

(16) A sixteenth embodiment is method of forming an image according to the thirteenth embodiment, wherein the irradiation light source of the actinic ray is an ultraviolet light-emitting diode.

(17) A seventeenth embodiment is the method of forming an image according to the sixteenth embodiment, wherein the ultraviolet light-emitting diode is an ultraviolet light-emitting diode emitting ultraviolet light at a wavelength of approximately 365 nm.

(18) An eighteenth embodiment is an inkjet-recording ink set, comprising a liquid A containing at least an image-forming polymerizable or crosslinkable material and a second liquid B having a different composition from the liquid A, wherein at least one of the liquids A or B is the cationic polymerizable composition according to the first embodiment.

(19) A nineteenth embodiment is an inkjet-recording method, comprising recording a desired image on a recording medium by using the ink set according to the eighteenth embodiment, the method further comprising:

applying the second liquid B on the recording medium in an area identical to or larger than an image to be formed with the liquid A; and

ejecting the liquid A containing an image-forming polymerizable or crosslinkable material at least as a first droplet a1 and a second droplet a2 thereon;

wherein the droplets a1 and a2 are ejected to partially overlap.

### EXAMPLES

Hereinafter, the invention will be described specifically with reference to Examples, however it should be understood that the invention is not restricted to the following Examples, within the scope of the invention.

In the following Examples, the cationic polymerizable compound according to the invention will be described, by taking ink compositions as examples, however the cationic polymerizable compound according to the invention is not limited thereto.

<Preparation of Pigment Dispersion>

First, the pigment and the dispersant shown in Table 1 were placed in a ball mill, and pulverized by using zircon beads having a diameter of 0.6 mm for 16 hours, to give a pigment dispersion. The average particle diameter of the pigment dispersion was measured under a transmission electron microscope (TEM). Measurement results are summarized in Table 1.

TABLE 1

| | Pigment | Pigment |
|---|---|---|
| | disper- | disper- |
| | sion-1 | sion-2 |
| Pigment (mass %) | | |
| Irgalite Blue GLVO (PB-15:4), | 20 | — |
| manufactured by CIBA SPECIALTY CHEMICALS | | |
| Chromophatal Jet Magenta DMQ (PR-122), | — | 20 |
| manufactured by CIBA SPECIALTY CHEMICALS | | |
| Polymerizable compound (mass %) | | |
| Monomer B (Aron Oxetane OXT-221, | 73 | 73 |
| manufactured by TOAGOSEI) | | |
| Dispersant (mass %) | | |
| Dispersant D-1 (having the following structure) | 7 | 7 |
| Average particle diameter (nm) | 91 | 87 |

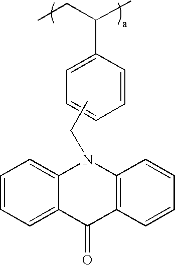

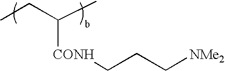

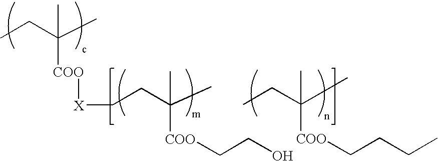

a:b:c = 20:10:70
m:n = 7:93
Dispersant D-1
X: divalent connecting group

The following partial structure in the dispersant D-1 derives from “AX-707S” manufactured by TOAGOSEI CO., LTD.

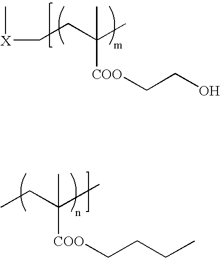

### Comparative Example 1-1

The following components were mixed by stirring and filtered through a 5.0-μm membrane filter, to give a cyan ink (sample 100).

<Sample 101: Components for Ink Composition>
Monomer A: (Celoxide 2021: manufactured by DAICEL UCB) 20 g
Monomer B: bis[1-ethyl(3-oxetanyl)]methylether 43 g (Aron Oxetane OXT-221, manufactured by TOAGOSEI CO., LTD.)
Monomer C: 3-ethyl-3-(2-ethylhexyloxymethyl)oxetane 30 g (Aron Oxetane OXT-212, manufactured by TOAGOSEI CO., LTD.)
Pigment dispersion: pigment dispersion-1 shown in Table 1 10 g
Photopolymerization initiator: S-1 (following structure) 6.0 g
Sensitizer: 9,10-dibutoxyanthracene 3.0 g
Surfactant: BYK307 (manufactured by BYK CHEMIE) 0.2 g

### Examples 1-1 to 1-7 and Comparative Examples 1-2 to 1-8

Cyan inks (samples 100 to 114) of Examples 1-1 to 1-7 and Comparative Examples 1-2 to 1-8 were prepared in a similar manner to Comparative Example 1, except that the monomers A, B, and C used in Comparative Example 1 were replaced with the monomers shown in Table 2.

The amount of the bifunctional oxetane compounds shown in Table 2 is an amount including the amount of the bifunctional oxetane compound contained in the pigment dispersion.

TABLE 2

| | | Bifunctional oxirane compound | | Bifunctional oxetane compound | | Monofunctional monomer | |
|---|---|---|---|---|---|---|---|
| | | | Addition | | Addition | | Addition |
| | Sample number | Kind | amount | Kind | amount | Kind | amount |
| Comparative | 100 | Monomer A | 25 | Monomer B | 50 | Monomer C | 25 |
| Example 1-1 | | | | | | | |
| Comparative | 101 | ME-1 | 25 | Monomer B | 50 | Monomer C | 25 |
| Example 1-2 | | | | | | | |
| Comparative | 102 | ME-2 | 25 | Monomer B | 50 | Monomer C | 25 |
| Example 1-3 | | | | | | | |
| Comparative | 103 | Monomer A | 25 | MO-1 | 50 | Monomer C | 25 |
| Example 1-4 | | | | | | | |
| Example 1-1 | 104 | ME-1 | 25 | MO-1 | 50 | Monomer C | 25 |
| Example 1-2 | 105 | ME-2 | 25 | MO-1 | 50 | Monomer C | 25 |
| Example 1-3 | 106 | ME-2 | 25 | MO-1 | 50 | Monomer D | 25 |
| Example 1-4 | 107 | ME-1 | 50 | MO-1 | 25 | Monomer C | 25 |
| Example 1-5 | 108 | ME-2 | 50 | MO-1 | 25 | Monomer C | 25 |
| Comparative | 109 | Monomer A | 30 | Monomer B | 70 | — | — |
| Example 1-5 | | | | | | | |
| Comparative | 110 | ME-1 | 30 | Monomer B | 70 | — | — |
| Example 1-6 | | | | | | | |
| Comparative | 111 | ME-2 | 30 | Monomer B | 70 | — | — |
| Example 1-7 | | | | | | | |
| Comparative | 112 | Monomer A | 30 | MO-1 | 70 | — | — |
| Example 1-8 | | | | | | | |
| Example 1-6 | 113 | ME-1 | 30 | MO-1 | 70 | — | — |
| Example 1-7 | 114 | ME-2 | 30 | MO-1 | 70 | — | — |

* The addition amount is an amount (g) with respect to 100 g of the total monomers.

Among the bifunctional oxirane and oxetane compounds shown in Table 2, “ME-1” and “ME-2” are specific oxirane compounds, and “MO-1” is a specific oxetane compound.

The structures of S-1 (photopolymerization initiator), ME-1 (specific oxirane compound), ME-2 (specific oxirane compound), MO-1 (specific oxetane compound), and monomer D are shown below.

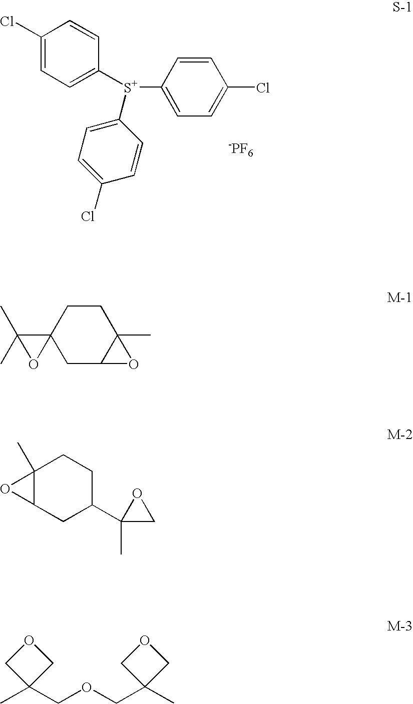

Monomer D: 3-Ethyl-3-phenoxymethyloxetane (Aron Oxetane OXT-212, manufactured by TOAGOSEI CO., LTD.)

<Evaluation>

1. Printing and Exposure Test

Each of the inks obtained in Examples and Comparative Examples was ejected with a piezoelectric head (CA-3, manufactured by TOSHIBA TEC CORP.). The conditions of the printing and exposure test were as follows:

The density of the head nozzles was 150/25.4 mm, and the ink was ejected on a medium at a density 150 droplets per 25.4 mm in the nozzle-arranging direction.

The temperature of the head and the ink liquid was kept 25° C.±1° C. during ejection.

Ink ejection from the head was controlled by the piezoelectric driving signal applied to the head, and droplets of 6 to 42 pl were able to be ejected from the head onto a medium traveling at a position 1 mm below the head, in the present Example. The traveling speed was able to be set in the range of 50 to 200 mm/s. In the present Examples and Comparative Examples, the ink droplets were ejected at a traveling speed of 90 mm/s of the medium and at an ink ejection amount of 24 pl per one ink droplet in an amount of 5 g/m² of the medium, to obtain a solid printed image.

After ejection, each sample was conveyed to a light irradiation region, where the printed image was exposed to the light from an ultraviolet light-emitting diode (UV-LED). In the present Examples and Comparative Examples, NCCU033 manufactured by Nichia Corporation was used as the UV-LED. The LED outputs a UV light at a wavelength of 365 nm from a chip and emits a light at an intensity of approximately 100 mW from the chip by energization of current at approximately 500 mA. Multiple LEDs were placed at an interval of 7 mm, giving a combined power of 0.3 W/cm² on the medium surface. The period from ink ejection to exposure and the period of light exposure were variable according to the medium traveling speed and the distance between the head and the LED in the conveying direction. In the present Examples and Comparative Examples, the images were exposed to light approximately 0.5 seconds after ink impingement onto the medium surface.

The exposure power and the light-exposure energy were values obtained by integration thereof in the wavelength range of 220 nm to 400 nm, as determined by using a spectroradiometer URS-40D manufactured by Ushio Inc.

In the present Examples and Comparative Examples, a PET film having a thickness of 100 μm was used as a medium, and the printing and exposure test was performed under an environment at 23° C. and 60% R.H. The thickness of the cured image was 4 μm.

2. Evaluation of Curing Property

The curing property was evaluated, based on the degree of transfer of a colorant to wood-free paper when the paper was superposed on a printed sample immediately after exposure and then pressed by a pressure roller (50 kg/cm²), according to the following criteria. Evaluation results are summarized in Table 3.

B: No transfer

C: Partial transfer

D: Almost entire transfer

3. Evaluation of Bending Resistance of Cured Film

A print sample of each ink that was printed that was not transferred and at the lowest energy was exposed to an environment in a weather meter for 10 days, and cracks of the cured film when it is bent to 180° were observed and evaluated according to the criteria below. Evaluation results are summarized in Table 3.

A: No cracking

B: No crack in the bent region at the center of sample was observed, but slight crack at the end portion was observabed.

C: Slight crack was observed in the center of the bent region.

D: Exfoliation of the cured film in the bent region

4. Evaluation of Nozzle Ejection Property

A line pattern image in a lattice shape was printed on another medium, inkjet paper (“Gasai”, gloss finished, manufactured by FUJI PHOTO FILM), over a period of one hour under the printing condition of the evaluation 1 above, and the lattice image thus formed was observed visually to evaluate the ejection property from the nozzles. The defective ejection rate is a rate (%) of the number of the incomplete dots in the number of the normally ejected dots from all nozzles.

B: Defective ejection rate in line image: 0% to 5%

C: Defective ejection rate in line image: 5% to 20

D: Defective ejection rate in line image: more than 20%

5. Evaluation of Ink Viscosity

The ink viscosity was determined at a liquid temperature 25° C., after the ink was stabilized after rotation with the rotor for 2 minutes, using RE80 viscometer (manufactured by TOKI SANGYO CO., LTD.).

TABLE 3

| | | Curing Property | | | | | | | |
|---|---|---|---|---|---|---|---|---|---|
| | Sample | | | | | 100 | Bending | Ejection | Ink viscosity |
| | number | 20 (mJ/cm²) | 30 (mJ/cm²) | 40 (mJ/cm²) | 50 (mJ/cm²) | (mJ/cm²) | resistance | property | (mPa · s) |
| Comparative | 100 | D | D | D | C | B | B | D | 27 |
| Example 1-1 | | | | | | | | | |
| Comparative | 101 | D | D | C | C | B | B | C | 15 |
| Example 1-2 | | | | | | | | | |
| Comparative | 102 | D | D | C | C | B | B | C | 15 |
| Example 1-3 | | | | | | | | | |
| Comparative | 103 | D | D | D | C | B | B | D | 25 |
| Example 1-4 | | | | | | | | | |
| Example 1-1 | 104 | C | B | B | B | B | A | B | 8 |
| Example 1-2 | 105 | C | B | B | B | B | A | B | 8 |
| Example 1-3 | 106 | C | B | B | B | B | A | B | 8 |
| Example 1-4 | 107 | C | C | B | B | B | A | B | 8 |
| Example 1-5 | 108 | C | C | B | B | B | A | B | 8 |
| Comparative | 109 | D | D | D | C | B | D | D | 30 |
| Example 1-5 | | | | | | | | | |
| Comparative | 110 | D | D | C | C | B | D | C | 16 |
| Example 1-6 | | | | | | | | | |
| Comparative | 111 | D | D | C | C | B | D | C | 16 |
| Example 1-7 | | | | | | | | | |
| Comparative | 112 | D | D | D | C | B | D | D | 28 |
| Example 1-8 | | | | | | | | | |
| Example 1-6 | 113 | C | B | B | B | B | B | B | 9 |
| Example 1-7 | 114 | C | B | B | B | B | B | B | 9 |

As shown in Table 3, each of the ink compositions of Examples 1-1 to 1-7 using the cationic polymerizable composition according to the invention (sample numbers 104 to 108 and 113 and 114) had a lower ink viscosity, a significant decrease in defective nozzle ejection rate, and high ejection stability. Each of the compositions had a high curability, even at a lower LED exposure energy.

In addition, the ink compositions of Examples 1-1 to 1-7 had also a high bending resistance of the cured films and in particular, the ink composition of Examples 1-1 to 1-5 containing a monofunctional monomer (monomer C or D) had a high bending resistance to cracking while a superior curing property was retained.

### Examples 2-1 to 2-7 and Comparative Examples 2-1 to 2-8

Magenta inks of Examples 2-1 to 2-7 and Comparative Examples 2-1 to 2-8 (samples 200 to 214) were prepared in a similar manner to Examples 1-1 to 1-7 and Comparative Examples 1-1 to 1-8, except that the pigment dispersions 1 in Examples 1-1 to 1-7 and Comparative Examples 1-1 to 1-8 were replaced with the pigment dispersions 2, and evaluated in a similar manner to the evaluation method and evaluation criteria described above. The results are summarized in Table 4.

TABLE 4

| | | Curing Property | | | | | | | |
|---|---|---|---|---|---|---|---|---|---|
| | Sample | | | | | 100 | Bending | Ejection | Ink viscosity |
| | number | 20 (mJ/cm²) | 30 (mJ/cm²) | 40 (mJ/cm²) | 50 (mJ/cm²) | (mJ/cm²) | resistance | property | (mPa · s) |
| Comparative | 200 | D | D | D | C | B | B | D | 31 |
| Example 2-1 | | | | | | | | | |
| Comparative | 201 | D | D | C | C | B | B | C | 17 |
| Example 2-2 | | | | | | | | | |
| Comparative | 202 | D | D | C | C | B | B | C | 18 |
| Example 2-3 | | | | | | | | | |
| Comparative | 203 | D | D | D | C | B | B | D | 27 |
| Example 2-4 | | | | | | | | | |
| Example 2-1 | 204 | D | C | B | B | B | A | B | 9 |
| Example 2-2 | 205 | D | C | B | B | B | A | B | 9 |
| Example 2-3 | 206 | D | C | B | B | B | A | B | 10 |
| Example 2-4 | 207 | D | C | B | B | B | A | B | 9 |
| Example 2-5 | 208 | D | C | B | B | B | A | B | 9 |
| Comparative | 209 | D | D | D | C | B | D | D | 34 |
| Example 2-5 | | | | | | | | | |
| Comparative | 210 | D | D | C | C | B | D | C | 17 |
| Example 2-6 | | | | | | | | | |
| Comparative | 211 | D | D | C | C | B | D | C | 19 |
| Example 2-7 | | | | | | | | | |
| Comparative | 212 | D | D | D | C | B | D | D | 26 |
| Example 2-8 | | | | | | | | | |
| Example 2-6 | 213 | D | C | B | B | B | B | B | 9 |
| Example 2-7 | 214 | D | C | B | B | B | B | B | 9 |

As shown in Table 4, each of the ink compositions of Examples 2-1 to 2-7 using the cationic polymerizable composition according to the invention (sample numbers 204 to 208 and 213 and 214) have a low viscosity, showed a significantly decreased nozzle imperfect ejection rate, and had superior ejection stability.

The ink compositions of Examples 2-1 to 2-7 had a high bending resistance of the cured film, and in particular, the ink compositions of Examples 2-1 to 2-5 containing a monofunctional monomer (monomer C or D) had a superior resistance to bending cracking while a superior curing property was retained.

### Comparative Example 3-1

(Preparation of Liquid I)

The polymerizable composition identical with the sample 100 obtained in Comparative Example 1-1 was prepared as liquid I.

(Preparation of Liquid II)

The polymerizable composition identical with the sample 100 obtained in Comparative Example 1-1 except that the pigment was removed was prepared as liquid II. (viscosity: 21 mPa·s)

(Image Recording and Evaluation)

An inkjet printer (test machine: IJET1000R2Head, manufactured by MICROJET, ejection frequency: 1 kHz, nozzle number: 64, two-row nozzle arrangement, droplet size: approximately 70 pl) was filled with the inkjet-recording liquids I and II prepared and the liquids were ejected in line from two heads, respectively. A polyethylene terephthalate (PET) sheet having a thickness of 60 μm (trade name: XEROX FILM OHP FILM for PPL/laser printer, manufactured by FUJI XEROX CO., LTD.) was used as a recording medium.

The interval between ejection of the liquid II and inkjet-recording liquid I was set to 400 milliseconds; the liquid II (second liquid B) was ejected first; and the inkjet-recording liquid I (first liquid A) was ejected then on the spot of the liquid II. The overlapping rate between adjacent droplets of solution II was controlled to 5% and the overlapping rate between adjacent droplets of inkjet-recording liquid I (first droplet a1 and first droplet a2) to 50%, by adjustment of the ejection frequency.

After ejection, the ejected liquids were irradiated with an ultraviolet ray at a wavelength of 365 nm at an intensity of 500 mJ/cm by using a metal halide lamp, leaving a recorded image.

An image was recorded by ejecting the liquid I on the spot of the solution II similarly, except that the liquid I was replaced with the sample 104 obtained in Example 1-1 or the sample 105 obtained in Example 1-2.

The liquids I and II were ejected in a line form to be overlapped each other, to give a image, and the quality of the line thus formed was observed. When the sample 100 was used as the liquid I (Comparative Example 1-1), there was disturbance in the ejected dot shape and line shape. In contrast, when sample 104 or 105 (cationic polymerizable composition according to the invention) was used as the liquid I, there was smaller disturbance in the dot shape and line shape, and thus a good image was obtained.

The invention provides a cationic polymerizable composition having a high curing property and a lower viscosity. The invention also provides an image-forming process, a recorded material, and an ink set using the cationic polymerizable ink composition or the ink composition, and an inkjet-recording method having superior ejection stability.

All publications, and technical standards mentioned in this specification are herein incorporated by reference to the same extent as if each individual publication, patent application, or technical standard was specifically and individually indicated to be incorporated by reference.

What is claimed is:

1. A cationic polymerizable composition, comprising at least one oxetane compound containing an unsubstituted methyl group and at least one oxirane compound containing an unsubstituted methyl group.

2. The cationic polymerizable composition of claim 1, wherein the at least one oxirane compound containing an unsubstituted methyl group has two or more oxirane rings.

3. The cationic polymerizable composition of claim 1, wherein the at least one oxetane compound containing an unsubstituted methyl group has two or more oxetane rings.

4. The cationic polymerizable composition of claim 2, wherein the at least one oxetane compound containing an unsubstituted methyl group has two or more oxetane rings.

5. The cationic polymerizable composition of claim 1, further comprising a monofunctional oxirane compound and/or a monofunctional oxetane compound other than the at least one oxetane compound containing an unsubstituted methyl group and the at least one oxirane compound containing an unsubstituted methyl group.

6. The cationic polymerizable composition of claim 1, further comprising a colorant.

7. The cationic polymerizable composition of claim 6, wherein the colorant is a pigment.

8. The cationic polymerizable composition of claim 6, wherein the colorant is an oil-soluble dye.

9. The cationic polymerizable composition of claim 1, further comprising a polymerization initiator.

10. The cationic polymerizable composition of claim 1, further comprising a sensitizer.

11. The cationic polymerizable composition of claim 1, for use in image formation.

12. A recorded material, prepared by using the cationic polymerizable composition of claim 1.

13. A method of forming an image, comprising:
applying the cationic polymerizable composition of claim 1 on a recording medium imagewise; and
curing the cationic polymerizable composition applied on the recording medium by irradiation with an actinic ray.

14. The method of forming an image of claim 13, wherein the cationic polymerizable composition is ejected from an inkjet nozzle during the application.

15. The method of forming an image of claim 13, wherein the irradiation light source of the actinic ray is a light-emitting diode or a semiconductor laser.

16. The method of forming an image of claim 13, wherein the irradiation light source of the actinic ray is an ultraviolet light-emitting diode.

17. The method of forming an image of claim 16, wherein the ultraviolet light-emitting diode is an ultraviolet light-emitting diode emitting ultraviolet light at a wavelength of approximately 365 nm.

18. An inkjet-recording ink set, comprising a liquid A containing at least an image-forming polymerizable or crosslinkable material and a second liquid B having a different composition from the liquid A, wherein at least one of the liquids A or B is the cationic polymerizable composition of claim 1.

19. An ink jet-recording method, comprising recording a desired image on a recording medium by using the ink set of claim 18, the method further comprising:
applying the second liquid B on the recording medium in an area identical to or larger than an image to be formed with the liquid A; and
ejecting the liquid A containing an image-forming polymerizable or crosslinkable material at least as a first droplet a1 and a second droplet a2 thereon;
wherein the droplets a1 and a2 are ejected to partially overlap.
